(19) United States
(12) Patent Application Publication
(10) Pub. No.: US 2025/0357667 A1
(43) Pub. Date: Nov. 20, 2025

(54) ANTENNA MODULE

(71) Applicant: Delta Electronics, Inc., Taoyuan City (TW)

(72) Inventors: Chieh-Tsao HWANG, Taoyuan City (TW); Yen-Ting CHEN, Taoyuan City (TW); Siang-Rong HSU, Taoyuan City (TW)

(21) Appl. No.: 18/797,774

(22) Filed: Aug. 8, 2024

(30) Foreign Application Priority Data
May 16, 2024 (CN) 202410611414.1

(51) Int. Cl. H01Q 9/04

(52) U.S. Cl. CPC H01Q 9/0414; H01Q 9/0457

(57) ABSTRACT

An antenna module is provided. The antenna module is adapted to transmit a wireless signal. The antenna module includes a first dielectric layer, a ground layer, a first radiator, a feed conductor, a second dielectric layer, a second radiator and a third dielectric layer. The first dielectric layer includes a first surface and a second surface. The ground layer is disposed on the first surface. The first radiator is disposed on the second surface. The feed conductor is coupled to the first radiator. The second dielectric layer includes a third surface and a fourth surface, wherein the second dielectric layer covers the first radiator, and the third surface contacts the first radiator and the second surface. The second radiator is disposed on the fourth surface. The third dielectric layer is disposed on the fourth surface and covers the second radiator.

### CROSS REFERENCE TO RELATED APPLICATIONS

This application claims priority of China Patent Application No. 202410611414.1, filed on May 16, 2024, the entirety of which is incorporated by reference herein.

### BACKGROUND OF THE INVENTION

### Field of the Invention

The invention relates to an antenna module, and, in particular, to a patch antenna module.

### Description of the Related Art

A conventional patch antenna module has two stacked dielectric layers, two stacked radiators, and a ground layer. Conventionally, the impedance bandwidth of an antenna module is generally less than 5%. Additionally, in common configurations, the antenna module must be connected to chips (such as beamformer ICs). The heat generated by the chips can affect the reliability and lifespan of the antenna module. Therefore, how to enhance the bandwidth of an antenna module is a challenging task.

### BRIEF SUMMARY OF THE INVENTION

An embodiment of the invention provides an antenna module. The antenna module is adapted to transmit a wireless signal. The antenna module includes a first dielectric layer, a ground layer, a first radiator, a feed conductor, a second dielectric layer, a second radiator and a third dielectric layer. The first dielectric layer includes a first surface and a second surface, wherein the first surface is opposite to the second surface, and the first dielectric layer has a first dielectric constant. The ground layer is disposed on the first surface. The first radiator is disposed on the second surface, wherein the first radiator has a first radiator area. The feed conductor is coupled to the first radiator. The second dielectric layer includes a third surface and a fourth surface, wherein the third surface is opposite to the fourth surface, the second dielectric layer covers the first radiator, the third surface contacts the first radiator and the second surface, and the second dielectric layer has a second dielectric constant. The second radiator is disposed on the fourth surface, wherein the second radiator has a second radiator area, the first radiator area is greater than the second radiator area, and on a projection surface, the second radiator is completely within the projection region defined by the first radiator. The third dielectric layer is disposed on the fourth surface and covers the second radiator, wherein the third dielectric layer has a third dielectric constant, the first dielectric constant is greater than the third dielectric constant, and the third dielectric constant is greater than the second dielectric constant.

In one embodiment, the third dielectric constant is equal to the average of the first dielectric constant and the second dielectric constant.

In one embodiment, the second radiator area is less than or equal to 0.75 times the first radiator area.

In one embodiment, the first radiator is square, the first radiator has a first side-length, the second radiator is square, the second radiator has a second side-length, and the second side-length is less than or equal to 0.86 times the first side-length.

In one embodiment, the first dielectric layer has a first thickness, the second dielectric layer has a second thickness, the third dielectric layer has a third thickness, the third thickness is greater than the first thickness, and the third thickness is greater than the second thickness.

In one embodiment, the third thickness is less than twice the first thickness.

In one embodiment, the wireless signal has a center frequency wavelength, and the first thickness is equal to 0.045 times the center frequency wavelength.

In one embodiment, the feed conductor passes through the ground layer and the first dielectric layer, and one end of the feed conductor is connected to the bottom surface of the first radiator.

In one embodiment, the feed conductor is disposed on the second surface, the feed conductor is sandwiched between the first dielectric layer and the second dielectric layer, and one end of the feed conductor is connected to a lateral surface of the first radiator.

In one embodiment, the antenna module further includes a fourth dielectric layer, wherein the fourth dielectric layer comprises a fifth surface and a sixth surface, the fifth surface is connected to the ground layer, the ground layer is sandwiched between the first dielectric layer and the fourth dielectric layer, the sixth surface is opposite to the fifth surface, the feed conductor is situated on the sixth surface, and the feed conductor corresponds to the first radiator.

Compared to the conventional art, the antenna module of the embodiment of the invention has an increased bandwidth and maintains good reliability and lifespan, even when the antenna module is connected to chips (such as beamformer ICs).

### BRIEF DESCRIPTION OF THE DRAWINGS

The invention can be more fully understood by reading the subsequent detailed description and examples with references made to the accompanying drawings, wherein:

FIG. 1 is a cross sectional view of an antenna module of a first embodiment of the invention;

FIG. 2 is a top view of the antenna module of the first embodiment of the invention (wherein the third dielectric layer is omitted);

FIG. 3 is a cross sectional view of an antenna module of a second embodiment of the invention;

FIG. 4 is a cross sectional view of an antenna module of a third embodiment of the invention;

FIG. 5 shows the input matching data (S11) of the antenna module of the first embodiment of the invention compared to the conventional art; and

FIG. 6 shows the total efficiency data of the antenna module of the first embodiment of the invention compared to the conventional art.

### DETAILED DESCRIPTION OF THE INVENTION

The following description is made for the purpose of illustrating the general principles of the invention and should not be taken in a limiting sense. The scope of the invention is best determined by reference to the appended claims.

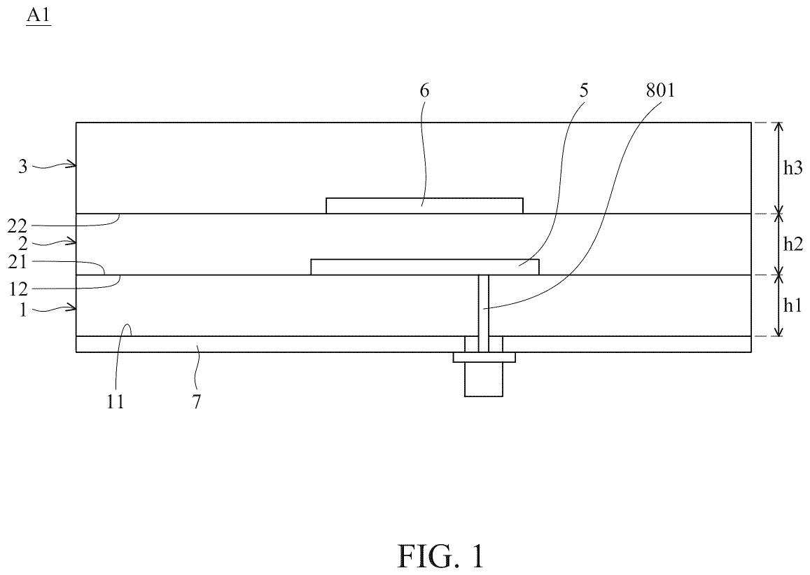

FIG. 1 is a cross sectional view of an antenna module of a first embodiment of the invention. With reference to FIG. 1, the antenna module A1 of the first embodiment of the invention is adapted to transmit a wireless signal. The antenna module A1 includes a first dielectric layer 1, a ground layer 7, a first radiator 5, a feed conductor 801, a second dielectric layer 2, a second radiator 6, and a third dielectric layer 3. The first dielectric layer 1 includes a first surface 11 and a second surface 12. The first surface 11 is opposite to the second surface 12. The first dielectric layer 1 has a first dielectric constant. The ground layer 7 is disposed on the first surface 11. The first radiator 5 is disposed on the second surface 12. The first radiator 5 has a first radiator area. The feed conductor 801 is coupled to the first radiator 5. The second dielectric layer 2 includes a third surface 21 and a fourth surface 22. The third surface 21 is opposite to the fourth surface 22. The second dielectric layer 2 covers the first radiator 5. The third surface 21 contacts the first radiator 5 and the second surface 12. The second dielectric layer 2 has a second dielectric constant. The second radiator 6 is disposed on the fourth surface 22. The second radiator 6 has a second radiator area. The third dielectric layer 3 is disposed on the fourth surface 22 and covers the second radiator 6. The third dielectric layer 3 has a third dielectric constant. The first dielectric constant is greater than the third dielectric constant. The third dielectric constant is greater than the second dielectric constant.

In one embodiment, by configuring the third dielectric layer, and by configuring the relative dielectric constants of the dielectric layers, the bandwidth of the antenna module is increased.

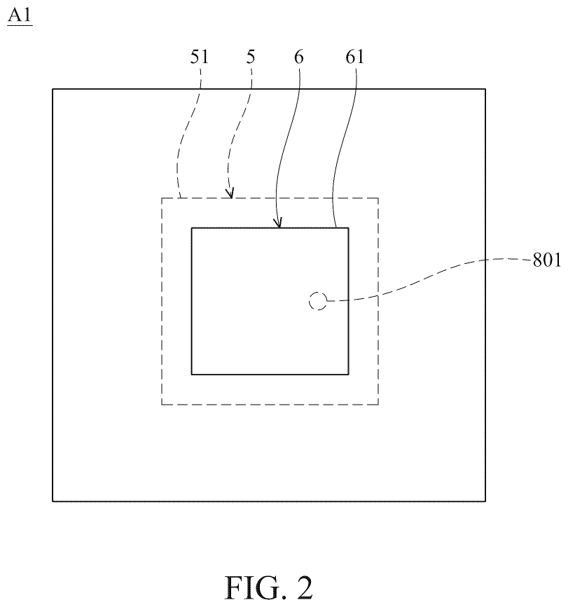

FIG. 2 is a top view of the antenna module of the first embodiment of the invention (wherein the third dielectric layer is omitted). With reference to FIGS. 1 and 2, in this embodiment, the first radiator area of the first radiator 5 is greater than the second radiator area of the second radiator 6. On a projection surface, the second radiator 6 is completely within the projection region defined by the first radiator 5. In one embodiment, the sizing configuration of the radiators can generate two frequency responses within the operating frequency band, and thus the range of the operating frequency band of the antenna module can be modified thereby.

In one embodiment, the third dielectric constant is equal to the average of the first dielectric constant and the second dielectric constant. The disclosure is not meant to restrict the invention. In one embodiment, the third dielectric constant may be slightly greater than or less than the average of the first dielectric constant and the second dielectric constant. For example, in one embodiment, the first dielectric constant can be 3.5, the second dielectric constant can be 2.2, and the third dielectric constant can be 2.8.

In one embodiment, the second radiator area is less than or equal to 0.75 times the first radiator area.

With reference to FIG. 2, in one embodiment, the first radiator 5 is square. The first radiator 5 has a first side-length 51. The second radiator 6 is square. The second radiator 6 has a second side-length 61. The second side-length 61 is less than or equal to 0.86 times the first side-length 51.

With reference to FIG. 1, in one embodiment, the first dielectric layer 1 has a first thickness h1. The second dielectric layer 2 has a second thickness h2. The third dielectric layer 3 has a third thickness h3. The third thickness h3 is greater than the first thickness h1. The third thickness h3 is greater than the second thickness h2. In one embodiment, by configuring the thicknesses of the dielectric layers as described above, the bandwidth of the antenna module is increased.

With reference to FIG. 1, in one embodiment, the third thickness h3 is less than twice the first thickness h1. In one embodiment, the first thickness h1 is equal to the second thickness h2. The disclosure is not meant to restrict the invention. For example, in one embodiment, the first thickness h1 can be 0.5 mm, the second thickness h2 can be 0.5 mm, and the third thickness h3 can be 0.76 mm.

With reference to FIG. 1, in one embodiment, the wireless signal has a center frequency wavelength, and the first thickness h1 is equal to 0.045 times the center frequency wavelength.

With reference to FIG. 1, in one embodiment, the feed conductor 801 passes through the ground layer 7 and the first dielectric layer 1, and one end of the feed conductor 801 is connected to the bottom surface of the first radiator 5.

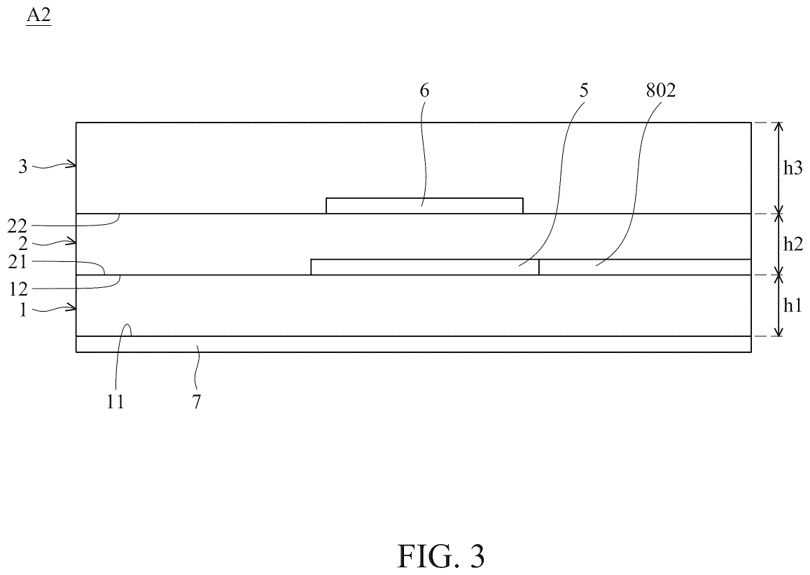

FIG. 3 is a cross sectional view of an antenna module of a second embodiment of the invention. With reference to FIG. 3, in one embodiment, the feed conductor 802 of the antenna module A2 is disposed on the second surface 12. The feed conductor 802 is sandwiched between the first dielectric layer 1 and the second dielectric layer 2. One end of the feed conductor 802 is connected to a lateral surface of the first radiator 5.

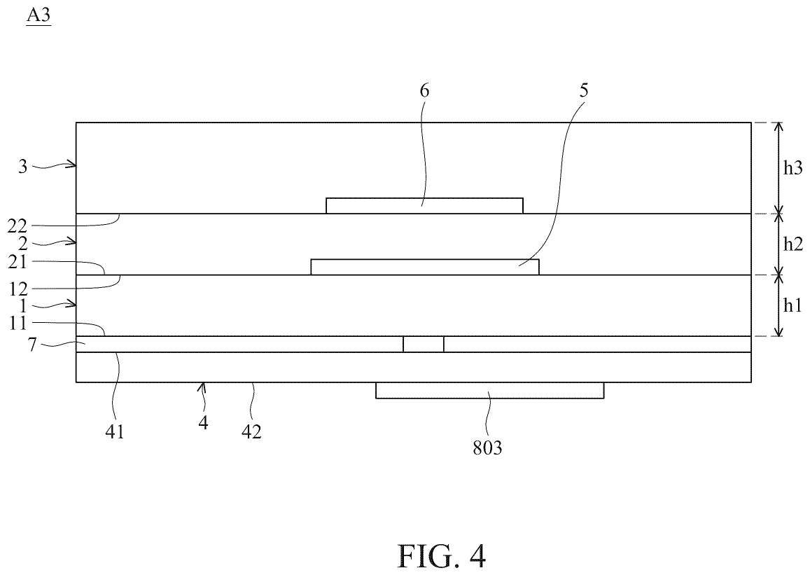

FIG. 4 is a cross sectional view of an antenna module of a third embodiment of the invention. With reference to FIG. 4, the antenna module A3 of this embodiment further includes a fourth dielectric layer 4. The fourth dielectric layer 4 comprises a fifth surface 41 and a sixth surface 42. The fifth surface 41 is connected to the ground layer 7. The ground layer 7 is sandwiched between the first dielectric layer 1 and the fourth dielectric layer 4. The sixth surface 42 is opposite to the fifth surface 41. The feed conductor 803 is situated on the sixth surface 42. The feed conductor 803 corresponds to the first radiator 5. In this embodiment, the feed conductor 803 feeds the signal by coupling.

In the above second and third embodiments, although the signal feeding is performed in different ways, the bandwidth enhancement effect similar to the first embodiment can still be achieved.

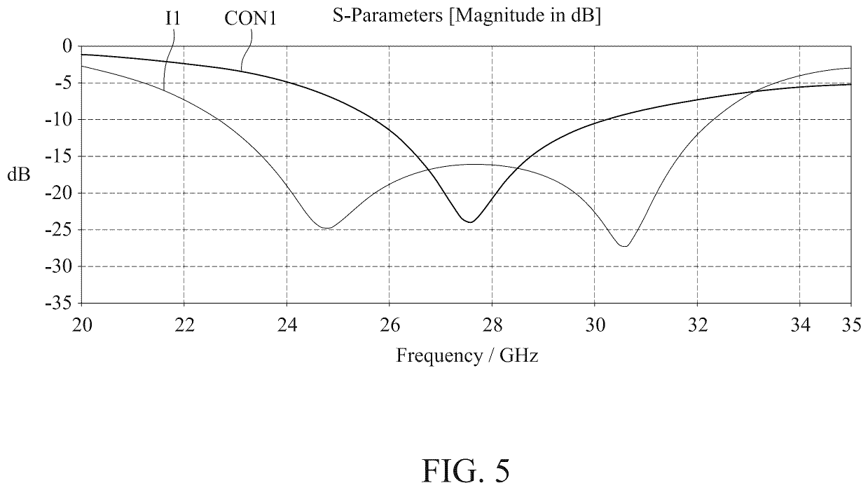

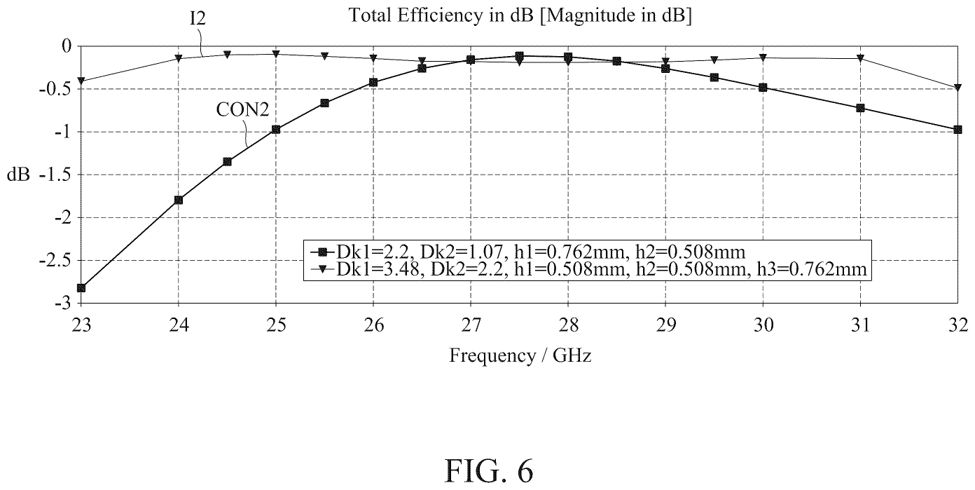

FIG. 5 shows the input matching data (S11) of the antenna module of the first embodiment of the invention compared to the conventional art, wherein CON1 represents the input matching data of the conventional art and I1 represents the input matching data of the antenna module of the first embodiment of the invention. FIG. 6 shows the total efficiency data of the antenna module of the first embodiment of the invention compared to the conventional art, wherein CON2 represents the total efficiency data of the conventional art and I2 represents the total efficiency data of the antenna module of the first embodiment of the invention. With reference to FIGS. 5 and 6, compared to the conventional art, the operating frequency band of the antenna module of the first embodiment of the invention covers the range between 26 GHz and 32 GHz, wherein the value of S11 can be below −10 dB, and the total efficiency value can be greater than −0.5 dB. Compared to the conventional art, the bandwidth of the antenna module of the first embodiment of the invention can be increased by approximately 33%. The antenna module of the embodiment of the invention has an increased bandwidth and maintains good reliability and lifespan, even when the antenna module is connected to chips (such as beamformer ICs).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna module, adapted to transmit a wireless signal, comprising:
a first dielectric layer, comprising a first surface and a second surface, wherein the first surface is opposite to the second surface, and the first dielectric layer has a first dielectric constant;
a ground layer, disposed on the first surface;
a first radiator, disposed on the second surface, wherein the first radiator has a first radiator area;
a feed conductor, coupled to the first radiator;
a second dielectric layer, comprising a third surface and a fourth surface, wherein the third surface is opposite to the fourth surface, the second dielectric layer covers the first radiator, the third surface contacts the first radiator and the second surface, and the second dielectric layer has a second dielectric constant;
a second radiator, disposed on the fourth surface, wherein the second radiator has a second radiator area, the first radiator area is greater than the second radiator area, and on a projection surface, the second radiator is completely within the projection region defined by the first radiator; and
a third dielectric layer, disposed on the fourth surface and covering the second radiator, wherein the third dielectric layer has a third dielectric constant, the first dielectric constant is greater than the third dielectric constant, and the third dielectric constant is greater than the second dielectric constant.

2. The antenna module as claimed in claim 1, wherein the third dielectric constant is equal to the average of the first dielectric constant and the second dielectric constant.

3. The antenna module as claimed in claim 1, wherein the second radiator area is less than or equal to 0.75 times the first radiator area.

4. The antenna module as claimed in claim 1, wherein the first radiator is square, the first radiator has a first side-length, the second radiator is square, the second radiator has a second side-length, and the second side-length is less than or equal to 0.86 times the first side-length.

5. The antenna module as claimed in claim 1, wherein the first dielectric layer has a first thickness, the second dielectric layer has a second thickness, the third dielectric layer has a third thickness, the third thickness is greater than the first thickness, and the third thickness is greater than the second thickness.

6. The antenna module as claimed in claim 5, wherein the third thickness is less than twice the first thickness.

7. The antenna module as claimed in claim 5, wherein the wireless signal has a center frequency wavelength, and the first thickness is equal to 0.045 times the center frequency wavelength.

8. The antenna module as claimed in claim 1, wherein the feed conductor passes through the ground layer and the first dielectric layer, and one end of the feed conductor is connected to the bottom surface of the first radiator.

9. The antenna module as claimed in claim 1, wherein the feed conductor is disposed on the second surface, the feed conductor is sandwiched between the first dielectric layer and the second dielectric layer, and one end of the feed conductor is connected to a lateral surface of the first radiator.

10. The antenna module as claimed in claim 1, further comprising a fourth dielectric layer, wherein the fourth dielectric layer comprises a fifth surface and a sixth surface, the fifth surface is connected to the ground layer, the ground layer is sandwiched between the first dielectric layer and the fourth dielectric layer, the sixth surface is opposite to the fifth surface, the feed conductor is situated on the sixth surface, and the feed conductor corresponds to the first radiator.
